(19) United States
(12) Patent Application Publication
(10) Pub. No.: US 2019/0224852 A1
(43) Pub. Date: Jul. 25, 2019

(54) ASSISTANT ROBOT AND OPERATION METHOD THEREOF

(71) Applicant: LG ELECTRONICS INC., Seoul (KR)

(72) Inventors: Jieun CHOI, Seoul (KR); Hyoungrock KIM, Seoul (KR)

(73) Assignee: LG ELECTRONICS INC., Seoul (KR)

(21) Appl. No.: 16/340,943

(22) PCT Filed: Sep. 1, 2017
(86) PCT No.: PCT/KR2017/009592

§ 371 Date: Apr. 10, 2019

(30) Foreign Application Priority Data
Oct. 11, 2016 (KR) 10-2016-0131452

(51) Int. Cl. B25J 9/16; G08B 5/22; B25J 11/00; B25J 19/00; H02J 7/00

(52) U.S. Cl. CPC B25J 9/1679; G08B 5/22; B25J 11/00; G06F 3/0488; B25J 11/008; H02J 7/0052; H02J 7/0047; B25J 19/0066

(57) ABSTRACT

An assistant robot for assisting a robot according to an embodiment of the present invention includes a communication unit for transmitting or receiving data; and a controller for controlling a charging module for charging a battery of a robot and an operation of the assistant robot, wherein the controller performs control to check a battery level of the robot, determine whether to perform charge, on the basis of the checked battery level, connect the charging module to the robot on the basis of the determination on whether to perform charge, and charge the battery of the robot up to a predetermined battery level.

### TECHNICAL FIELD

The present invention relates to a robot provided in an airport and an operating method thereof, and more particularly to an airport assistant robot to assist a plurality of robots provided in an airport and an operating method thereof.

### BACKGROUND ART

Recently, as deep learning technology, self-driving technology, automatic control technology, and Internet of things (IoT) advance, it is possible to implement intelligent robots.

Each technology will be described below in detail. Deep learning corresponds to the field of machine learning. The deep learning is technology which allows a program to perform similar determination on various situations, instead of a method where a condition and a command are previously set in a program. Therefore, according to the deep learning, computers may think similar to brains of humans and may analyze massive data.

Self-driving is technology where a machine determines and moves autonomously to avoid an obstacle. According to the self-driving technology, a robot autonomously recognizes and moves a position through a sensor to avoid an obstacle.

The automatic control technology denotes technology where a machine feeds back a measurement value, obtained by inspecting a machine state, to a control device to automatically control an operation of the machine. Therefore, control may be performed without manipulation by a user, and control may be automatically performed so that a desired control target reaches a desired range.

IoT denotes intelligent technology and service where all things are connected to one another over Internet and information exchanges between a user and a thing and between a thing and a thing. Devices connected to Internet through IoT transmit or receive information to perform autonomous communication, without the help of a user.

The application fields of robots are generally classified into industrial robots, medical robots, universal robots, and seabed robots. For example, in machine processing industry such as production of vehicles, robots may perform an iterative work. That is, industrial robots which learn an operation performed by arms of persons once and repeat the same operation for much time are being applied.

The robot having the above feature may cause an unexpected failure due to the device characteristic. The failure may cause an unexpected fatal result. Although a component having high reliability is selected to cope with the above problem, there still is a probability of causing the failure due to the external disturbance, the error in the realization procedure, or an environment. To prevent this, a fault tolerant system may be applicable to the robot. The fault tolerant system may allow a robot to keep operating even if the whole robot performance is degraded, instead of completely stopping the whole operation of the robot when there occurs a situation in which a portion of the robot does not operate normally.

### DISCLOSURE

### Technical Problem

An object of the present invention is to prevent an airport robot from stopping operating by constantly maintaining a battery level to a predetermine level or more.

Another object of the present invention is to minimize the number of times that an assistant robot, which charges an airport robot, stops by a charging station

Still another object of the present invention is to prevent an airport robot from repeatedly calling an assistant robot by transmitting a request message several times.

Still another object of the present invention is to allow an airport assistant robot to perform a function of an airport robot, when the number of airport robots is insufficient in a specific area of an airport.

### Technical Solution

According to the present invention, an airport assistant robot may include a charging module and may receive a charging requesting message in real time. In addition, an airport robot having transmitted the charging requesting message may be charged such that a battery level of the airport robot is equal to or greater than a preset level.

According to the present invention, an airport assistant robot may charge the battery of the airport robot only to the preset battery level. The airport assistant robot may charge the airport robot only to the battery level allowing moving to a charging station.

According to the present invention, the airport assistant robot may include a cleaning module or a repairing module, in addition to the charging module. Accordingly, the airport assistant robot may automatically provide an auxiliary function such as cleaning or repairing while charging the airport robot without a request.

According to the present invention, the airport assistant robot may be equipped with various service functions, such as a guiding function, of a typical airport robot. Accordingly, a user may request an airport assistant robot to provide a direction guide service, instead of an airport robot.

### Advantageous Effects

According to the present invention, an airport assistant robot may charge the battery of the airport robot in real time while moving a predetermined area of an airport. Accordingly, the airport robot may maintain a battery state of a predetermined level or more and may avoid the situation of stopping the operation thereof.

According to the present invention, the airport assistant robot may perform a charging operation such that the airport robot has battery power in the extent of moving to the charging station. Accordingly, the airport assistant robot may resolve charging requests of airport robots as many as possible, in the state that the airport assistant robot is fully charged with power.

According to the present invention, the airport assistant robot may simultaneously provide auxiliary functions, such as charging, cleaning, or repairing, to the airport robot. Accordingly, the airport robot may be prevented from transmitting several request messages several times.

According to the present invention, the airport assistant robot may simultaneously provide auxiliary functions, such as charging, cleaning, or repairing, to the airport robot. Accordingly, the airport robot may be prevented from transmitting several request messages several times.

### BRIEF DESCRIPTION OF DRAWINGS

FIG. 1 is a block diagram illustrating a hardware configuration of an airport robot according to an embodiment of the present invention.

FIG. 2 is a diagram illustrating in detail a configuration of each of a microcomputer and an application processor (AP) of an airport robot according to another embodiment of the present invention.

FIG. 3 is a diagram illustrating the structure of an airport robot system according to an embodiment of the present invention.

FIG. 4 is a view illustrating that an assistant robot is randomly provided in an airport according to an embodiment of the present invention.

FIGS. 5 to 7 are views illustrating the operation of a server to manage an assistant robot according to an embodiment of the present invention.

FIG. 8 is a view illustrating that the assistant robot performs a patrol operation in the airport according to an embodiment of the present invention.

FIG. 9 is a view illustrating that an assistant robot moves together with the airport robot in a docking state according to an embodiment of the present invention.

FIG. 10 is a view illustrating that an assistant robot charges the airport robot according to an embodiment of the present invention.

FIG. 11 is a view illustrating that an assistant robot cleans a dust canister of an airport robot according to an embodiment of the present invention.

FIG. 12 is a view illustrating that an assistant robot cleans a dust canister of an airport robot according to an embodiment of the present invention.

FIG. 13 is a view illustrating that an assistant robot performs a function of a guiding robot according to an embodiment of the present invention.

FIG. 14 is a view illustrating that the assistant robot performs a walking assisting operation according to an embodiment of the present invention.

FIG. 15 is a block diagram illustrating the components of the airport assistant robot according to an embodiment of the present invention.

### BEST MODE

Hereinafter, an embodiment according to the present invention will be described in more detail with reference to accompanying drawings.

Suffixes of components, such as “module” and “unit”, which are employed in the following description, are merely intended to facilitate description of the specification, and the suffix itself is not intended to give any special meaning or function.

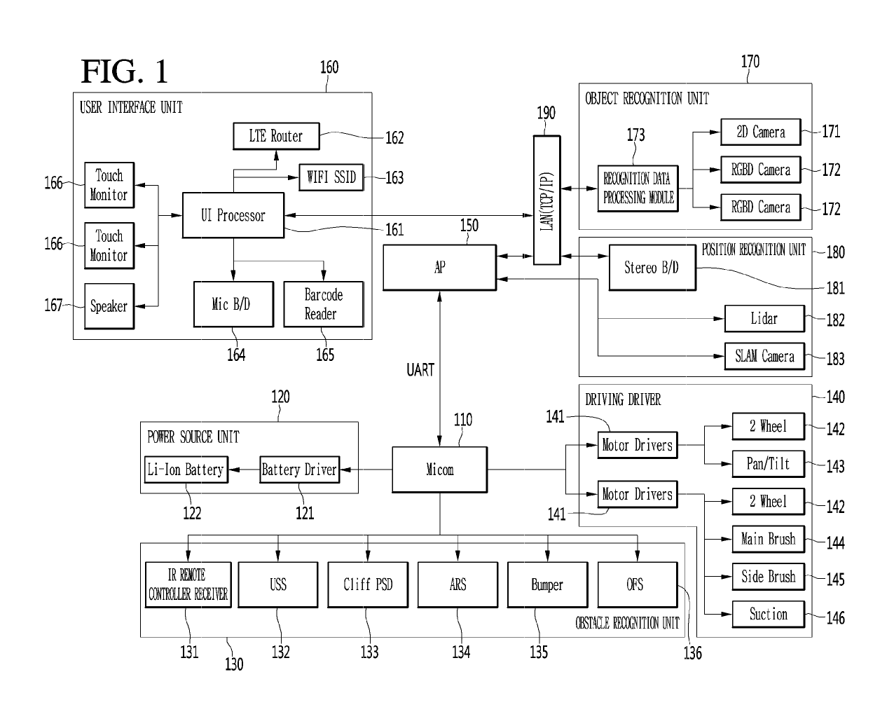

FIG. 1 is a block diagram illustrating a hardware configuration of an airport robot according to an embodiment of the present invention.

As illustrated in FIG. 1, hardware of the airport robot according to an embodiment of the present invention may be configured with a microcomputer group and an AP group. The microcomputer group may include a microcomputer 110, a power source unit 120, an obstacle recognition unit 130, and a driving driver 140. The AP group may include an AP 150, a user interface unit 160, an object recognition unit 170, a position recognition unit 180, and a local area network (LAN) 190.

The microcomputer 110 may manage the power source unit 120 including a battery of the hardware of the airport robot, the obstacle recognition unit 130 including various kinds of sensors, and the driving driver 140 including a plurality of motors and wheels.

The power source unit 120 may include a battery driver 121 and a lithium-ion (li-ion) battery 122. The battery driver 121 may manage charging and discharging of the li-ion battery 122. The li-ion battery 122 may supply power for driving the airport robot. The li-ion battery 122 may be configured by connecting two 24V/102A li-ion batteries in parallel.

The obstacle recognition unit 130 may include an infrared (IR) remote controller receiver 131, an ultrasonic sensor (USS) 132, a cliff PSD 133, an attitude reference system (ARS) 134, a bumper 135, and an optical flow sensor (OFS) 136. The IR remote controller receiver 131 may include a sensor which receives a signal from an IR remote controller for remotely controlling the airport robot. The USS 132 may include a sensor for determining a distance between an obstacle and the airport robot by using an ultrasonic signal. The cliff PSD 133 may include a sensor for sensing a precipice or a cliff within a forward-direction airport robot driving range of 360 degrees. The ARS 134 may include a sensor for detecting a gesture of the airport robot. The ARS 134 may include a sensor which is configured with an acceleration 3-axis and a gyro 3-axis for detecting the number of rotations. The bumper 135 may include a sensor which senses a collision between the airport robot and an obstacle. The sensor included in the bumper 135 may sense a collision between the airport robot and an obstacle within a 360-degree range. The OFS 136 may include a sensor for measuring a phenomenon where a wheel is spinning in driving of the airport robot and a driving distance of the airport robot on various floor surfaces.

The driving driver 140 may include a motor driver 141, a wheel motor 142, a rotation motor 143, a main brush motor 144, a side brush motor 145, and a suction motor 146. The motor driver 141 may perform a function of driving the wheel motor, the brush motor, and suction motor for driving and cleaning of the airport robot. The wheel motor 142 may drive a plurality of wheels for driving of the airport robot. The rotation motor 143 may be driven for a lateral rotation and a vertical rotation of a head unit of the airport robot or a main body of the airport robot, or may be driven the direction change or rotation of a wheel of the airport robot. The main brush motor 144 may drive a brush which sweeps filth on an airport floor. The side brush motor 145 may drive a brush which sweeps filth in a peripheral area of an outer surface of the airport robot. The suction motor 146 may be driven for sucking filth on the airport floor.

The AP 150 may function as a central processing unit which manages a whole hardware module system of the airport robot. The AP 150 may transmit, to the microcomputer 110, user input/output information and application program driving information for driving by using position information obtained through various sensors, thereby allowing a motor or the like to be performed.

The user interface unit 160 may include a user interface (UI) processor 161, a long term evolution (LTE) router 162, a WIFI SSID 163, a microphone board 164, a barcode reader 165, a touch monitor 166, and a speaker 167. The user interface processor 161 may control an operation of the user interface unit which performs an input/output of a user. The LTE router 162 may receive necessary information from the outside and may perform LTE communication for transmitting information to the user. The WIFI SSID 163 may analyze WIFI signal strength to perform position recognition on a specific object or the airport robot. The microphone board 164 may receive a plurality of microphone signals, process a sound signal into sound data which is a digital signal, and analyze a direction of the sound signal and a corresponding sound signal. The barcode reader 165 may read barcode information described in a plurality of targets used in airport. The touch monitor 166 may include a monitor for displaying output information and a touch panel which is configured for receiving the input of the user. The speaker 167 may inform the user of specific information through a voice.

The object recognition unit 170 may include a two-dimensional (2D) camera 171, a red, green, blue, and distance (RGBD) camera 172, and a recognition data processing module 173. The 2D camera 171 may be a sensor for recognizing a person or an object on the basis of a 2D image. The RGBD camera 172 may be a camera including RGBD sensors or may be a sensor for detecting a person or an object by using captured images including depth data obtained from other similar three-dimensional (3D) imaging devices. The recognition data processing module 173 may process a signal such as 2D image/video or 3D image/video obtained from the 2D camera and the RGBD camera 172 to recognize a person or an object.

The position recognition unit 180 may include a stereo board (B/D) 181, a light detection and ranging (LIDAR) 182, and a simultaneous localization and mapping (SLAM) camera 183. The SLAM camera 183 may implement simultaneous position tracing and mapping technology. The airport robot may detect ambient environment information by suing the SLAM camera 183 and may process obtained information to generate a map corresponding to a duty performing space and simultaneously estimate its absolute position. The LIDAR 182, a laser radar, may be a sensor which irradiates a laser beam and collects and analyzes rearward-scattered light of light absorbed or scattered by aerosol to perform position recognition. The stereo board 181 may process sensing data collected from the LIDAR 182 and the SLAM camera 183 to manage data for recognizing a position of the airport robot and an obstacle.

The LAN 190 may perform communication with the user interface processor 161 associated with a user input/output, the recognition data processing module 173, the stereo board 181, and the AP 150.

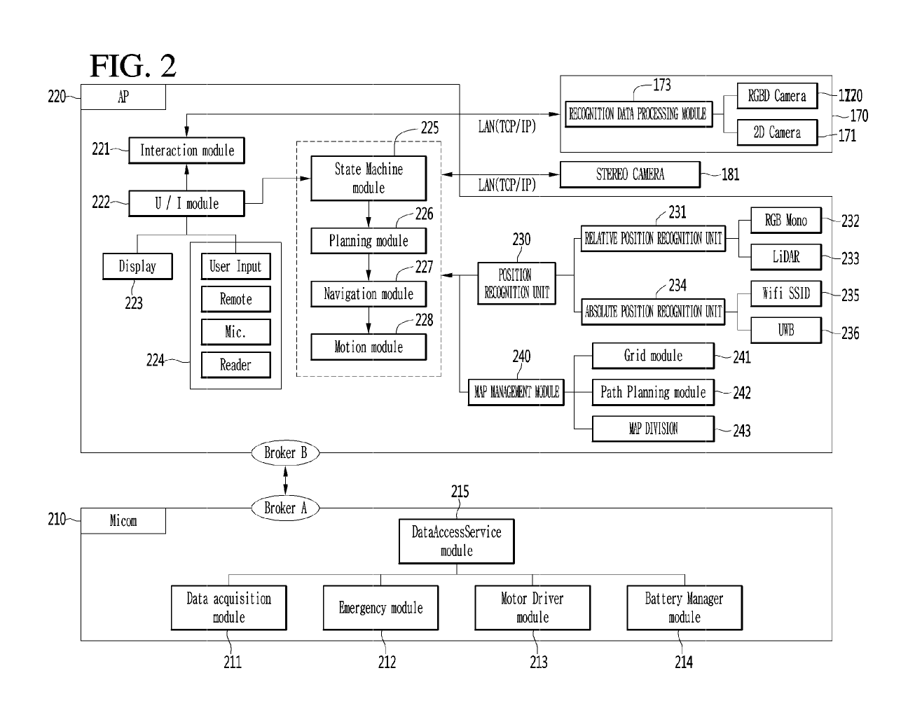

FIG. 2 is a diagram illustrating in detail a configuration of each of a microcomputer and an AP of an airport robot according to another embodiment of the present invention.

As illustrated in FIG. 2, a microcomputer 210 and an AP 220 may be implemented as various embodiments, for controlling recognition and action of the airport.

For example, the microcomputer 210 may include a data access service module 215. The data access service module 215 may include a data acquisition module 211, an emergency module 212, a motor driver module 213, and a battery manager module 214. The data acquisition module 211 may acquire data sensed from a plurality of sensors included in the airport robot and may transfer the acquired data to the data access service module 215. The emergency module 212 may be a module for sensing an abnormal state of the airport robot, and when the airport robot performs a predetermined type action, the emergency module 212 may sense that the airport robot is in the abnormal state. The motor driver module 213 may manage a wheel, a brush, and driving control of a suction motor for driving and cleaning of the airport robot. The battery manager module 214 may manage charging and discharging of the li-ion battery 122 of FIG. 1 and may transfer a battery state of the airport robot to the data access service module 215.

The AP 220 may receive, recognize, and process a user input and the like to control an operation of the airport robot with various cameras and sensors. An interaction module 221 may be a module which synthesizes recognition data received from the recognition data processing module 173 and a user input received from a user interface module 222 to manage software exchanged between a user and the airport robot. The user interface module 222 may receive a close-distance command of the user such as a key, a touch screen, a reader, and a display unit 223 which is a monitor for providing manipulation/information and a current situation of the airport robot, or may receive a long-distance signal such as a signal of an IR remote controller for remotely controlling the airport robot, or may manage a user input received of a user input unit 224 receiving an input signal of the user from a microphone, a barcode reader, or the like. When one or more user inputs are received, the user interface module 222 may transfer user input information to a state machine module 225. The state machine module 225 which has received the user input information may manage a whole state of the airport robot and may issue an appropriate command corresponding to a user input. A planning module 226 may determine a start time and an end time/action for a specific operation of the airport robot according to the command transferred from the state machine module 225 and may calculate a path through which the airport will move. A navigation module 227 may be a module which manages overall driving of the airport robot and may allow the airport robot to drive along a driving path calculated by the planning module 226. A motion module 228 may allow the airport robot to perform a basic operation in addition to driving.

Moreover, the airport robot according to another embodiment of the present invention may include a position recognition unit 230. The position recognition unit 230 may include a relative position recognition unit 231 and an absolute position recognition unit 234. The relative position recognition unit 231 may correct a movement amount of the airport robot through an RGM mono sensor 232, calculate a movement amount of the airport robot for a certain time, and recognize an ambient environment of the airport robot through a LIDAR 233. The absolute position recognition unit 234 may include a WIFI SSID 235 and a UWB 236. The WIFI SSID 235 may be an UWB sensor module for recognizing an absolute position of the airport robot and may be a WIFI module for estimating a current position through WIFI SSID sensing. The WIFI SSID 235 may analyze WIFI signal strength to recognize a position of the airport robot. The UWB 236 may calculate a distance between a transmission unit and a reception unit to sense the absolute position of the airport robot.

Moreover, the airport robot according to another embodiment of the present invention may include a map management module 240. The map management module 240 may include a grid module 241, a path planning module 242, and a map division module 243. The grid module 241 may manage a lattice type map generated by the airport robot through an SLAM camera or map data of an ambient environment, previously input to the airport robot, for position recognition. In map division for cooperation between a plurality of airport robots, the path planning module 242 may calculate driving paths of the airport robots. Also, the path planning module 242 may calculate a driving path through which the airport robot will move. Also, the path planning module 242 may calculate a driving path through which the airport robot will move in an environment where one airport robot operates. The map division module 243 may calculate in real time an area which is to be managed by each of a plurality of airport robots.

Pieces of data sensed and calculated from the position recognition unit 230 and the map management module 240 may be again transferred to the state machine module 225. The state machine module 225 may issue a command to the planning module 226 so as to control an operation of the airport robot, based on the pieces of data sensed and calculated from the position recognition unit 230 and the map management module 240.

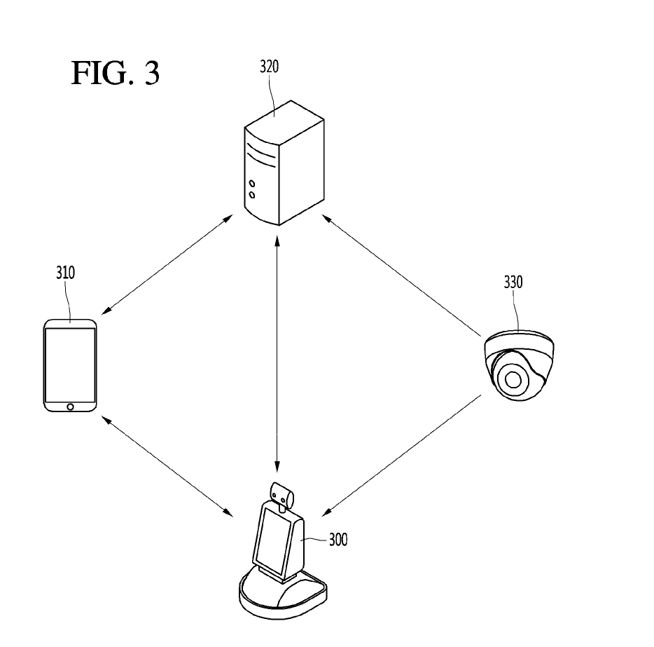

FIG. 3 is a diagram illustrating the structure of an airport robot system according to an embodiment of the present invention.

The airport robot system according to the embodiment of the present invention may include a mobile terminal 310, a server 320, an airport robot 300, and a camera 330.

The mobile terminal 310 may transmit and receive data to and from the server 320 in the airport. For example, the mobile terminal 310 may receive airport related data such as a flight time schedule, an airport map, etc. from the server 320. A user may receive necessary information of the airport from the server 320 through the mobile terminal 310. In addition, the mobile terminal 310 may transmit data such as a photo, a moving image, a message, etc. to the server 320. For example, the user may transmit the photograph of a missing child to the server 320 to report the missing child or photograph an area of the airport where cleaning is required through the camera to request cleaning of the area.

In addition, the mobile terminal 310 may transmit and receive data to and from the airport robot 300.

For example, the mobile terminal 310 may transmit, to the airport robot 300, a signal for calling the airport robot 300, a signal for instructing that specific operation is performed, or an information request signal. The airport robot 300 may move to the position of the mobile terminal 310 or perform operation corresponding to the instruction signal in response to the call signal received from the mobile terminal 310. Alternatively, the airport robot 300 may transmit data corresponding to the information request signal to the mobile terminal 310 of the user.

The airport robot 300 may perform patrol, guidance, cleaning, disinfection and transportation within the airport.

The airport robot 300 may transmit and receive signals to and from the server 320 or the mobile terminal 310. For example, the airport robot 300 may transmit and receive signals including information on the situation of the airport to and from the server 320. In addition, the airport robot 300 may receive image information of the areas of the airport from the camera 330 in the airport. Accordingly, the airport robot 300 may monitor the situation of the airport through the image information captured by the airport robot 300 and the image information received from the camera 330.

The airport robot 300 may directly receive a command from the user. For example, a command may be directly received from the user through input of touching the display unit provided in the airport robot 300 or voice input. The airport robot 300 may perform patrol, guidance, cleaning, etc. according to the command received from the user, the server 320, or the mobile terminal 310.

Next, the server 320 may receive information from the airport robot 300, the camera 330, and/or the mobile terminal 310. The server 320 may collect, store and manage the information received from the devices. The server 320 may transmit the stored information to the airport robot 300 or the mobile terminal 310. In addition, the server 320 may transmit command signals to a plurality of the airport robots 300 disposed in the airport.

The camera 330 may include a camera installed in the airport. For example, the camera 330 may include a plurality of closed circuit television (CCTV) cameras installed in the airport, an infrared thermal-sensing camera, etc. The camera 330 may transmit the captured image to the server 320 or the airport robot 300.

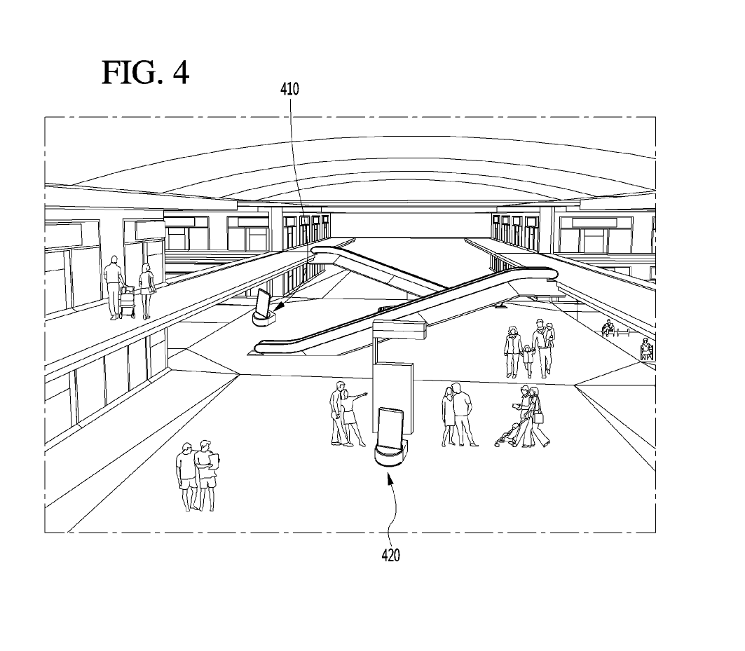

FIG. 4 is a view illustrating that an assistant robot is randomly provided in an airport according to an embodiment of the present invention.

As illustrated in FIG. 4, assistant robots 410 and 420 according to an embodiment of the present invention may be randomly provided in a predetermined area of an airport. For example, the first assistant robot 410 may be provided around an entrance gate or a ticketing counter in which a lot of people are gathered. In addition, the second assistant robot 420 may be provided around an electronic display board or a column in which a lot of people are not gathered.

The assistant robots 410 and 420 in the airport may assist and manage an airport robot which provides various services such as a guiding service, a security service, or a cleaning service. For example, the assistant robot may directly charge the battery of an airport robot when the battery level of the airport robot is decreased to a preset level. In addition, the assistant robot may personally repair a predetermined device of an airport device, when the predetermined device of the airport device is broken down. In addition, when the predetermined device of the airport device is broken down, the assistant robot may transmit, to an appointed manager in charge or an appointed management server in charge, a message for notifying that the predetermined device of the airport robot is broken down. In addition, when the wheel of the airport robot is broken down and thus it is difficult for the airport robot to move, the assistant robot may personally move the relevant airport robot to a specified place such as a repairing place.

As illustrated in FIG. 4, assistant robots are provided in specific positions of the airport, thereby increasing the efficiency of maintaining, repairing, and managing of a plurality of airport robots scattered in the airport to provide services. In addition, the assistant robots 410 and 420 may be docked at specific positions in the airport and thus may maintain the full charging state of the batteries of the assistant robots 410 and 420.

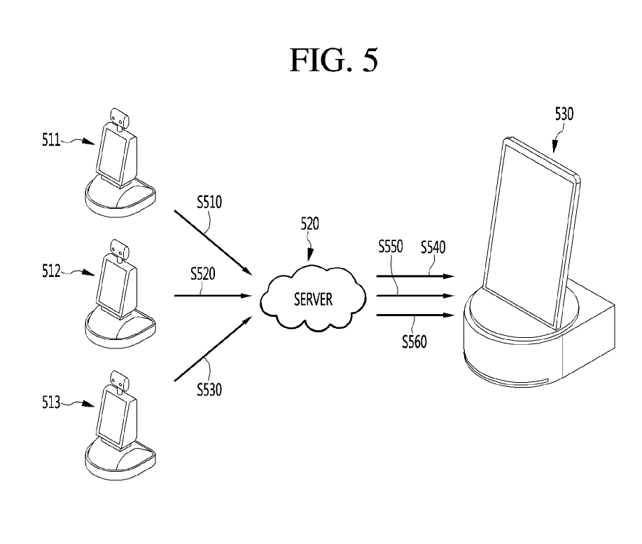

FIGS. 5 to 7 are views illustrating the operation of a server to manage the assistant robot according to an embodiment of the present invention.

As illustrated in FIG. 5, airport robots 511, 512, and 513 according to an embodiment of the present invention may provide various services. The airport robots 511, 512, and 513 to provide various services may transmit various request messages to the server.

For example, the first airport robot 511 may sense that the battery is reduced to less than a preset level, while providing a service. The first airport robot 511 having sensed the battery reduced to less than the preset level may transmit a message for requesting for charging the battery to the server 520 (S510).

In addition, the second airport robot 512 may sense that a predetermined device is broken down, while providing a service. The second airport robot 512 having sensed the predetermined device broken down may transmit a message for requesting for repairing the device to the server 520 (S520).

In addition, the third airport robot 513, which fails to perform a guiding function, may sense that a message for requesting for guiding is received from a user, while providing a service. The third airport robot 513 having received the message for requesting for guiding by the user may transmit the message for requesting for guiding to the server 520 (S530).

The server 520 having received the three requesting messages from the first airport robot 511, the second airport robot 512, and the third airport robot 513 may transmit messages to a managing robot 530, which is provided in a specific area of the airport, to manage the assistant robots. In other words, the server 520 may transmit the message for requesting for charging the battery, which is received from the first airport robot 511, to the managing robot 530 (S540). In addition, the server 520 may transmit the message for requesting for repairing the device, which is received from the second airport robot 512, to the managing robot 530 (S550). In addition, the server 520 may transmit the message for requesting for guiding, which is received from the third airport robot 513, to the managing robot 530 (S560).

The managing robot 530 may receive, from the server 520, the message for requesting for charging the battery, the message for requesting for repairing the device, and the message for requesting for guiding. Each message may include information on the airport robot having transmitted the message. Accordingly, the managing robot 530 may detect the information on the airport robot having transmitted each message from the message. In addition, the managing robot 530 may detect a current position of an airport robot having transmitted a relevant message. In addition, the managing robot 530 may detect an assistant robot provided at a place closest to the detected position. In addition, the managing robot 530 may transmit, to an assistant robot, which is provided at the closest place, a message for the execution of an operation corresponding to the requesting message from the airport message, which has transmitted to the message.

For example, the managing robot 530 may detect an assistant robot, which is positioned at a place closest to the first airport robot 511, of assistant robots to provide a function of charging a battery. In addition, the managing robot 530 may transmit a message for instructing charging of the battery of the first airport robot 511 to the detected assistant robot. In this case, the assistant robot may charge the battery of the first airport robot 511 fully or only to a predetermined battery level.

In addition, the managing robot 530 may detect an assistant robot, which is positioned at a place closest to the second airport robot 512, of assistant robots to provide a function of repairing a device. In addition, the managing robot 530 may transmit a message for instructing repairing of a predetermined device of the second airport robot 512 to the detected assistant robot. In this case, the assistant robot may perform one of work of repairing the device or work of replacing the device with new one, depending on the current state of the second airport robot 512.

In addition, the managing robot 530 may detect an assistant robot, which is positioned at a place closest to the third airport robot 513, of assistant robots to provide a function of guiding. In addition, the managing robot 530 may transmit a message for detecting a user who requests for guiding to the third airport robot 514 and of guiding the user, to the detected assistant robot. In this case, the assistant robot may receive user request information from the third airport robot 513. In addition, the assistant robot may provide, for the user, a predetermined guiding function corresponding to the user request information.

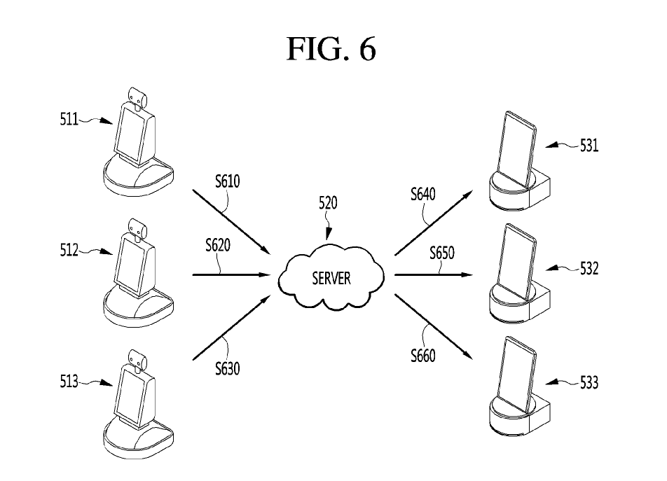

As illustrated in FIG. 6, the server 520 may directly transmit an instruction message to the assistant robot without passing through the managing robot 530.

As illustrated in FIG. 6, the airport robots 511, 512, and 513 according to an embodiment of the present invention may provide various services. The airport robots 511, 512, and 513 to provide various services may transmit various request messages, which include current positions thereof, to the server.

For example, the first airport robot 511 may sense that the battery is reduced to less than a preset level, while providing a service. The first airport robot 511 having sensed the battery reduced to less than the preset level may transmit a message for requesting for charging the battery, which includes the current position thereof, to a server 520 (S610).

In addition, the second airport robot 512 may sense that the predetermined device is broken down, while providing a service. The second airport robot 512 having sensed the predetermined device broken down may transmit a message for requesting for repairing the device, which includes the current position thereof, to a server 520 (S620).

In addition, the third airport robot 513, which fails to perform a guiding function, may sense that a message for requesting for guiding is received from a user, while providing a service. The third airport robot 513 having received the message for requesting for guiding by the user may transmit the message for requesting for guiding, which includes the current position thereof, to the server 520 (S630).

The server 520 having received, from the first airport robot 511, the second airport robot 512, and the third airport robot 513, three requesting messages including the current positions of the first airport robot 511, the second airport robot 512, and the third airport robot 513, may scan current position information of assistant robots provided in a specific area of the airport. In addition, the server 520 may detect assistant robots positioned at a place closest to the first airport robot 511, the second airport robot 512, and the third airport robot 513. In addition, the server 520 may transmit, to the assistant robots, which are provided at the closest place, messages for the execution of operations corresponding to the requesting messages from the airport robots, which have transmitted to the messages.

For example, the server 520 may detect an assistant robot, which is positioned at a place closest to the first airport robot 511, of assistant robots to provide a function of charging a battery. In addition, the server 520 may transmit a message for instructing charging of the battery of the first airport robot 511 to the detected assistant robot (S640). In this case, the assistant robot may charge the battery of the first airport robot 511 fully or only to a predetermined battery level.

In addition, the server 520 may detect an assistant robot, which is positioned at a place closest to the second airport robot 512, of assistant robots to provide a function of repairing the device. In addition, the managing robot 520 may transmit a message for instructing repairing of a predetermined device of the second airport robot 512 to the detected assistant robot (S650). In this case, the assistant robot may perform one of work of repairing the device or work of replacing the device with new one, depending on the current state of the second airport robot 512.

In addition, the server 530 may detect an assistant robot, which is positioned at a place closest to the third airport robot 513, of assistant robots to provide a function of guiding. In addition, the server 520 may transmit a message for detecting a user, who requests for guiding to the third airport robot 513, and for guiding the user, to the detected assistant robot (S660). In this case, the assistant robot may receive user request information from the third airport robot 513. In addition, the assistant robot may provide, for the user, a predetermined guiding function corresponding to the user request information.

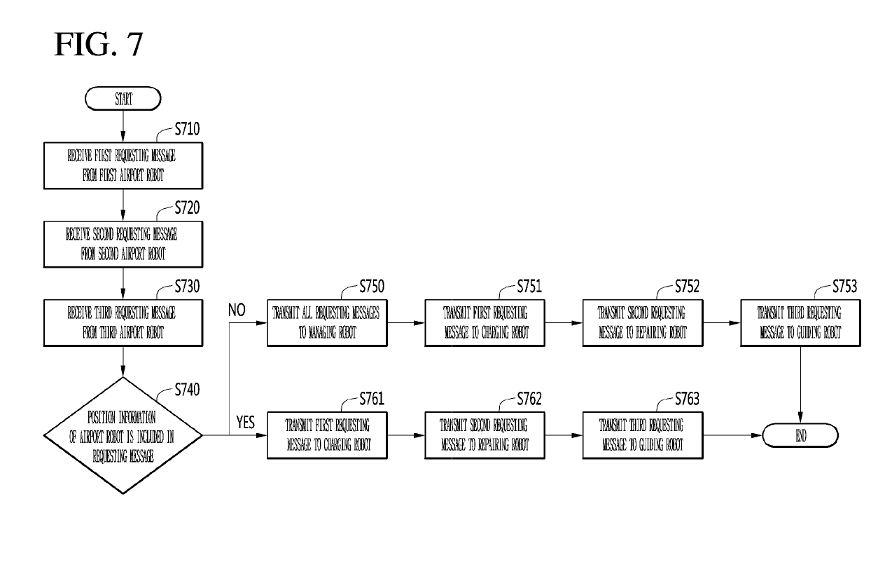

FIG. 7 is a flow chart illustrating an operating method of the server transmitting the requesting messages illustrated in FIGS. 5 and 6.

For example, the server 520 may receive a first requesting message from the first airport robot 511 (S710). The first requesting message may be the message for requesting for charging the battery.

For example, the server 520 may receive a second requesting message from the second airport robot 512 (S720). The second requesting message may be the message for requesting for repairing the device.

For example, the server 520 may receive a third requesting message from the third airport robot 513 (S730). The third requesting message may be the message for requesting for guiding.

In addition, the server 520 may determine whether to request a managing robot, which manages assistant robots, for the first requesting message, the second requesting message, and the third requesting message (S740). In this case, the server 520 may detect whether current position information of airport robots is included in the first requesting message, the second requesting message, and the third requesting message.

When the current position information of the airport robots is not included in the first requesting message, the second requesting message, and the third requesting message, the server 520 may transmit, to the managing robot, all the first requesting message, the second requesting message, and the third requesting message (S750).

The managing robot 530 may receive the first requesting message, the second requesting message, and the third requesting message from the server 520. In other words, the managing robot 530 may receive, from the server 520, the message for requesting for charging the battery, the message for requesting for repairing the device, and the message for requesting for guiding. Each message may include information on the airport robot having transmitted the message. Accordingly, the managing robot 530 may detect the information on the airport robot having transmitted each message from the message. In addition, the managing robot 530 may detect a current position of the airport robot having transmitted a relevant message. In addition, the managing robot 530 may detect the assistant robot provided at a place closest to the detected position. In addition, the managing robot 530 may transmit, to an assistant robot, which is provided at the closest place, a message for the execution of an operation corresponding to the requesting message from the airport message, which has transmitted to the message.

For example, the managing robot 530 may detect an assistant robot, which is positioned at a place closest to the first airport robot 511, of assistant robots to provide a function of charging a battery. In addition, the managing robot 530 may transmit a message for instructing charging of the battery of the first airport robot 511 to the detected assistant robot (S751). In this case, the assistant robot may charge the battery of the first airport robot 511 fully or only to a predetermined battery level.

For example, the managing robot 530 may detect an assistant robot, which is positioned at a place closest to the second airport robot 512, of assistant robots to provide a function of repairing the device. In addition, the managing robot 530 may transmit a message for instructing repairing the device of the second airport robot 512 to the detected assistant robot (S752). In this case, the assistant robot may perform one of work of repairing the device or work of replacing the device with new one, depending on the current state of the second airport robot 512.

For example, the managing robot 530 may detect an assistant robot, which is positioned at a place closest to the third airport robot 513, of assistant robots to provide a function of guiding. In addition, the managing robot 530 may transmit a message for detecting a user, who requests for guiding to the third airport robot 514, and for guiding the user, to the detected assistant robot (S753). In this case, the assistant robot may receive user request information from the third airport robot 513. In addition, the assistant robot may provide, for the user, a predetermined guiding function corresponding to the user request information.

Meanwhile, when the current position information of the airport robots is included in the first requesting message, the second requesting message, and the third requesting message, the server 520 may directly transmit, to the assistant robots, the first requesting message, the second requesting message, and the third requesting message.

For example, the server 520 may detect an assistant robot, which is positioned at a place closest to the first airport robot 511, of assistant robots to provide a function of charging a battery. In addition, the server 520 may transmit a message for instructing charging of the battery of the first airport robot 511 to the detected assistant robot (S761). In this case, the assistant robot may charge the battery of the first airport robot 511 fully or only to a predetermined battery level.

For example, the server 520 may detect an assistant robot, which is positioned at a place closest to the second airport robot 512, of assistant robots to provide a function of repairing a device. In addition, the server 530 may transmit a message for instructing repairing of a predetermined device of the second airport robot 512 to the detected assistant robot (S762). In this case, the assistant robot may perform one of work of repairing the device or work of replacing the device with new one, depending on the current state of the second airport robot 512.

For example, the server 530 may detect an assistant robot, which is positioned at a place closest to the third airport robot 513, of assistant robots to provide a function of guiding. In addition, the managing robot 520 may transmit a message for detecting a user who requests for guiding to the third airport robot 513 and for guiding the user, to the detected assistant robot (S763). In this case, the assistant robot may receive user request information from the third airport robot 513. In addition, the assistant robot may provide, for the user, a predetermined guiding function corresponding to the user request information.

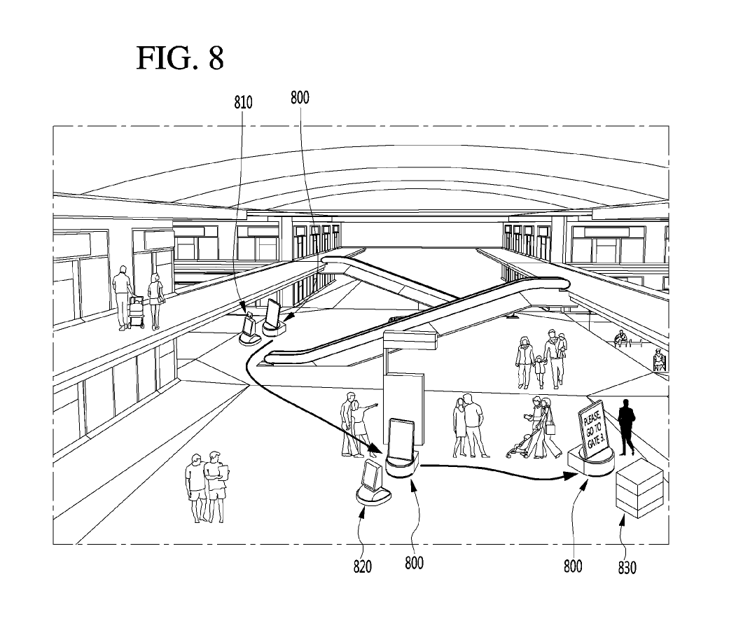

FIG. 8 is a view illustrating that the assistant robot performs a patrol operation in the airport according to an embodiment of the present invention.

An assistant robot 800 may include a mobile communication module, a wireless Internet module, a short-range communication module, and a position information module to make data communication with airport robots 810, 820, and 830.

The mobile communication module transmit or receive a radio signal at least one of a base station, an external terminal, or a server over a mobile communication network constructed based on technical standards or communication schemes (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSDPA), Long Term Evolution (LTE), Long Term Evolution-Advanced (LTE-A), or the like) for mobile communication.

The wireless signal may include various forms of data according to transmission/reception of a voice call signal, a video call signal or a text/multimedia message.

The wireless Internet module, which refers to a module for wireless Internet access, may be embedded in the assistant robot 800 and the airport robots 810, 820, and 830 or may be provided at the outside of the assistant robot 800 and the airport robots 810, 820, and 830. The wireless Intent module is provided to transmit/receive a wireless signal in a telecommunication network based on wireless Internet technologies.

A wireless Internet technology includes, for example, Wireless LAN (WLAN), Wireless-Fidelity (Wi-Fi), Wireless Fidelity (Wi-Fi) Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), or Long Term Evolution-Advanced (LTE-A). The wireless Internet module transmit or receive data based on at least one wireless Internet technology in the range including even an Internet technology which is not mentioned above.

The wireless Internet module performing wireless Internet access through the mobile communication network may be interpreted as a kind of a mobile communication module in that the wireless Internet access based on WiBro, HSDPA, HSUPA, GSM, CDMA, WCDMA, LTE, or LTE-A.

The short-range communication module, which is used for short range communication, may support short range communication by using at least one of BluetoothTM, Radio Frequency Identification (RFID), Infrared Data Association (IrDA), Ultra Wideband (UWB), ZigBee, Near Field Communication (NFC), Wireless-Fidelity (Wi-FI), Wi-Fi Direct, or Wireless Universal Serial Bus (Wireless USB). Such short-range communication module may support, through wireless area networks, wireless communication between the assistant robot 800 and the wireless communication system, the assistant robot 800 and the airport robots 810, 820, or 830, or between the assistant robot 800 and a network in which another assistant robot 800 (or external server) is positioned. The short range communication module may be a wireless personal area network.

A position information module, which is a module to acquire the position (or the current position) of the assistant robot, is representatively a global position system (GPS) or a wireless fidelity (WiFi) module. For example, when the GPS module is utilized, the assistant robot 800 may acquire the position of the assistant robot by using a signal transmitted from the GPS satellite. For another example, when the Wi-Fi module is utilized, the assistant robot 800 may acquire the position of the assistant robot 800 based on the information of a wireless access point (Wireless Access Point) transmitting or receiving the wireless signal together with the Wi-Fi module. If necessary, the position information module may perform any function of another module of the wireless communication unit by substituting for the another module or in addition to the another module, so as to acquire data associated with the position of the assistant robot.

As illustrated in FIG. 8, the assistant robot 800 according to an embodiment of the present invention may perform a petrol operation of continuously moving in a predetermined area of the airport. The assistant robot 800 may make data communication with the airport robots 810, 820, and 830 while performing the petrol operation. The airport robots 810, 820 and 830 may directly transmit at least one request message to the assistant robot 800 without passing through the server if necessary. The assistant robot 800 having received the at least one request message from the airport robots 810, 820, and 830 may determine the possibility of performing an operation corresponding to the request message. In addition, when the assistant robot 800 is able to perform the operation corresponding to the request message as the determination result, the assistant robot 800 may approach the airport robot, which has transmitted the relevant request message, and may perform the operation corresponding to the request message. Meanwhile, when the assistant robot 800 is able to perform the operation corresponding to the request message, the assistant robot 800 may transmit the relevant request message to the server. Alternatively, when the assistant robot 800 is able to perform the operation corresponding to the request message as the determination result, the assistant robot 800 may transmit the relevant request message to another assistant robot which is able to perform the operation corresponding to the request message.

For example, the first airport robot 810 may sense that the battery is reduced to less than a preset level, while providing a service. The first airport robot 810, which has sensed the battery reduced to less than a preset level, may sense that the assistant robot 800 performs a petrol operation within a preset range. The first airport robot 810 may transmit a message for requesting for charging the battery, which includes the current position thereof, to the assistant robot 800 using a wireless communication technology. The assistant robot 800 having received the message for requesting for charging the battery, from the first airport robot 810 may determine the possibility of performing a battery charging operation. The assistant robot 800, which is able to perform the battery charging operation as the determination result, may perform the charging of the battery of the first airport robot 810.

In addition, the second airport robot 820 may sense that the predetermined device is broken down, while providing a service. The second airport robot 820, which has sensed the predetermined device broken down, may sense that the assistant robot 800 performs a petrol operation within a preset range. The second airport robot 820 may transmit a message for requesting for repairing the device, which includes the current position thereof, to the assistant robot 800 using a wireless communication technology. The assistant robot 800 having received the message for requesting for repairing the device, from the second airport robot 820 may determine the possibility of performing a device repairing operation. The assistant robot 800, which is able to perform the device repairing operation as the determination result, may perform the repairing of the broken device of the second airport robot 820.

In addition, the third airport robot 830, which fails to perform a guiding function, may sense that a message for requesting for guiding is received from a user, while providing a service. The third airport robot 830, which has received the message for requesting for guiding, may sense that the assistant robot 800 performs a petrol operation within a preset range. The third airport robot 830 may transmit the message for requesting for guiding, which includes the current position thereof, to the assistant robot 800 using a wireless communication technology. The assistant robot 800 having received the message for requesting for guiding, from the third airport robot 830 may determine the possibility of performing a guiding operation. The assistant robot 800, which is able to perform the guiding operation as the determination result, may provide information necessary for a user who has requested the third airport robot 830 for guiding.

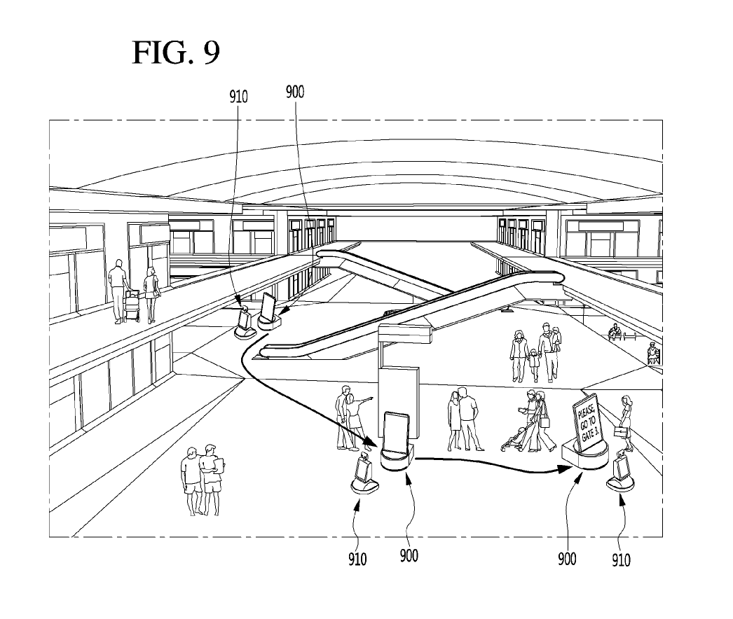

FIG. 9 is a view illustrating that an assistant robot moves together with the airport robot in a docking state according to an embodiment of the present invention.

As illustrated in FIG. 9, according to an embodiment of the present invention, an assistant robot 900 may move together with an airport robot 910 while charging the battery of the airport robot 910. For example, when the battery of the airport robot 910 performing the cleaning while circulating a specific area of an airport is insufficient, the assistant robot 900 performs docking on the airport robot 910 and may charge the battery of the airport robot 910. In this case, the assistant robot 900 docked on the airport robot 910 may move together with the airport 910. The assistant robot 900 and the airport robot 910 may maintain the docking state until the battery of the assistant robot 910 is charged to a preset level or more.

In addition, as illustrated in FIG. 9, the assistant robot 900 moving in the state of being docked on the airport robot 910 may perform an operation that the airport robot 910 is not able to perform, in place of the airport robot 910. For example, the airport robot 910 of FIG. 9 may perform only the cleaning and not perform a guiding operation. In this case, when a user requests the airport robot 910 to guide directions, the assistant robot 910 docked on the airport robot 900 may perform the direction guiding operation in place of the airport robot 900.

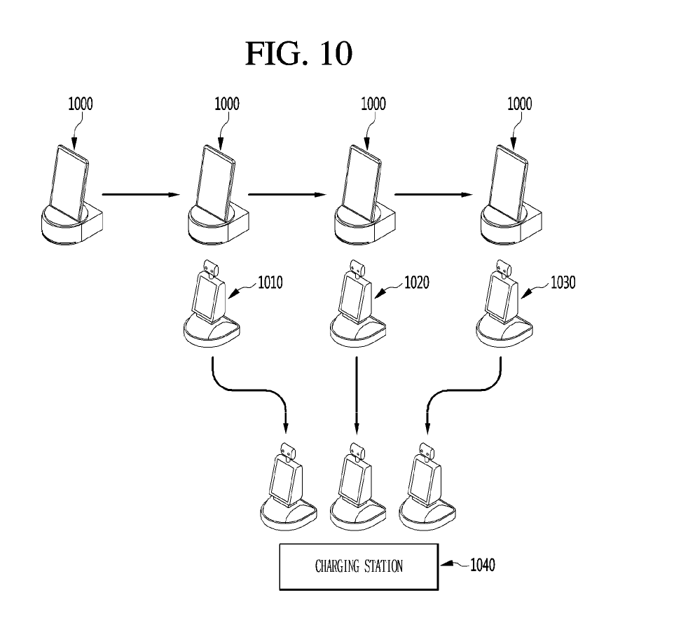

FIG. 10 is a view illustrating that an assistant robot charges the airport robot according to an embodiment of the present invention.

As illustrated in FIG. 10, an assistant robot 1000 according to an embodiment of the present invention may charge the batteries of a plurality of airport robots 1010, 1020, and 1030 while moving a predetermined area. In this case, the assistant robot 1000 may fully charge the batteries of the plurality of airport robots 1010, 1020, and 1030. Meanwhile, as illustrated in FIG. 10, the assistant robot 1000 may charge the batteries of the plurality of airport robots 1010, 1020, and 1030 such that the plurality of airport robots 1010, and 1020, 1030 hold only the minimum battery levels allowing the plurality of airport robots 101, 1020, and 1030 to move a charging station 1040.

For example, when the assistant robot 1000 attempts to charge the batteries of the plurality of airport robots 1010, 1020, and 1030, the assistant robot 1000 may request the plurality of airport robots 1010, 1020, and 1030 for position information of the plurality of airport robots 1010, 1020, and 1030. In addition, the assistant robot 1000 may calculate the distances between the plurality of airport robots 1010, 1020, and 1030 and the charging station 1040 by using the position information of the plurality of airport robots 1010, 1020, and 1030. Meanwhile, the assistant robot 1000 may charge the batteries of the plurality of airport robots 1010, 1020, and 1030 such that the plurality of airport robots 1010, and 1020, 1030 hold only the minimum battery levels allowing the plurality of airport robots 101, 1020, and 1030 to move the charging station 1040.

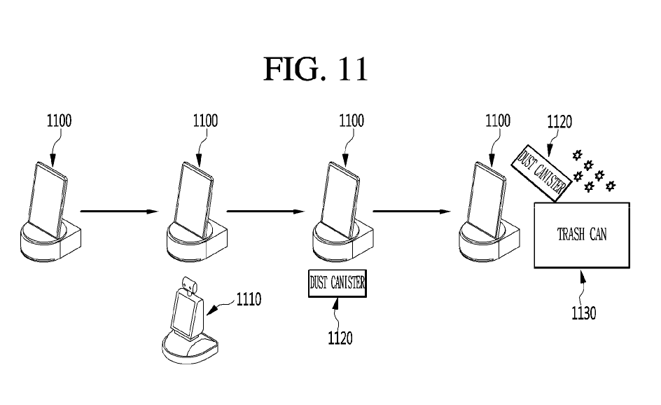

FIG. 11 is a view illustrating that an assistant robot cleans a dust canister of an airport robot according to an embodiment of the present invention.

According to an embodiment of the present invention, an assistant robot 1100 may charge the battery of an airport robot 1110 while moving a predetermined area. In this case, the assistant robot 1100 may fully charge the airport robot 1110. Meanwhile, as described with reference to FIG. 10, the assistant robot 1100 may charge the battery of the airport robot 1110 such that the airport robot 1110 holds only the minimum battery level allowing the airport robot 1110 to move a charging station.

In addition, as illustrated in FIG. 11, the airport robot 1110 may hold a dust canister 1120 for cleaning. In addition, when the airport robot 1110 performs cleaning for a predetermined time, a dust canister 1120 may have various dusts and garages. In this case, the assistant robot 1100 may sense the content of dust in the dust canister 1120 of the airport robot 1110 while charging the battery of the airport robot 1110. When the dust canister 1120 of the airport robot 1110 contains a preset amount or more of dust, the assistant robot 1100 may extract the dust canister 1120 from the airport robot 1110 after finishing the charging of the battery of the airport robot 1110. In addition, the assistant robot 1100 may bring the dust canister 1120 to a trash can 1130 in a preset area and may clean the dust and the garbage included in the dust canister 1120. In addition, the assistant robot 1100 may mount the dust canister 1120 on the airport robot 1110.

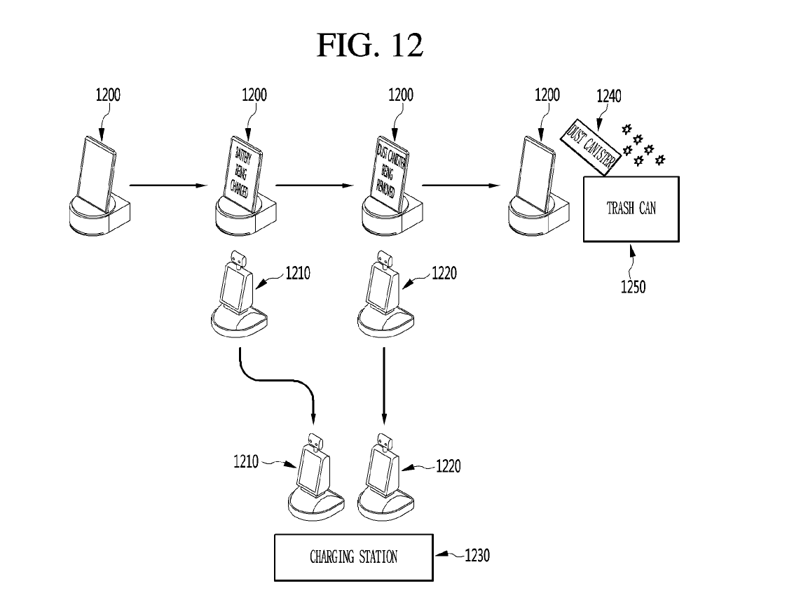

FIG. 12 is a view illustrating that an assistant robot cleans a dust canister of an airport robot according to an embodiment of the present invention.

According to an embodiment of the present invention, an assistant robot 1200 may charge the batteries of a plurality of airport robots 1210 and 1220 while moving a preset area. In this case, the assistant robot 1200 may fully charge the batteries of the plurality of airport robots 1210 and 1220. Meanwhile, as illustrated in FIG. 12, the assistant robot 1200 may charge the batteries of the plurality of airport robots 1210, and 1220 such that the plurality of airport robots 1210 and 1220 hold only the minimum battery levels allowing the plurality of airport robots 1210 and 1220 to move a charging station 1230. In addition, the assistant robot 1200 may output relevant information to the display unit while performing charging.

For example, the assistant robot 1200 may charge a portion of the battery of the first airport robot 1210 such that the first airport robot 1210 is able to move to the charging state 1230. In this case, the assistant robot 1200 may output, to the display unit, a message for notifying that the portion of the battery of the first airport robot 1210 is charged.

For example, the assistant robot 1200 may charge a portion of the battery of the second airport robot 1220 such that the second airport robot 1220 is able to move to the charging state 1230. The second airport robot 1220 may hold a dust canister 1240 for cleaning. In addition, when the second airport robot 1220 performs cleaning for a predetermined time, the dust canister 1240 may have various dusts and garages. In this case, the assistant robot 1200 may sense the content of dust in the dust canister 1240 of the second airport robot 1220 while charging the battery of the second airport robot 1220. When the dust canister 1240 of the second airport robot 1220 contains a preset amount or more of dust, the assistant robot 1200 may extract the dust canister 1240 from the second airport robot 1220 after finishing the charging of the battery of the second airport robot 1220. In addition, the assistant robot 1200 may bring the dust canister 1240 to a trash can 1250 in a preset area and may clean the dust and the garbage included in the dust canister 1240. In addition, the second airport robot 1220 having a portion of the battery charged with power by the assistant robot 1200 may fully charge a remaining portion of the battery after arriving at the charging station 1230. In addition, the assistant robot 1200 may mount the emptied dust canister 1240 on the second airport robot 1220 which is charging the battery at the charging station 1230.

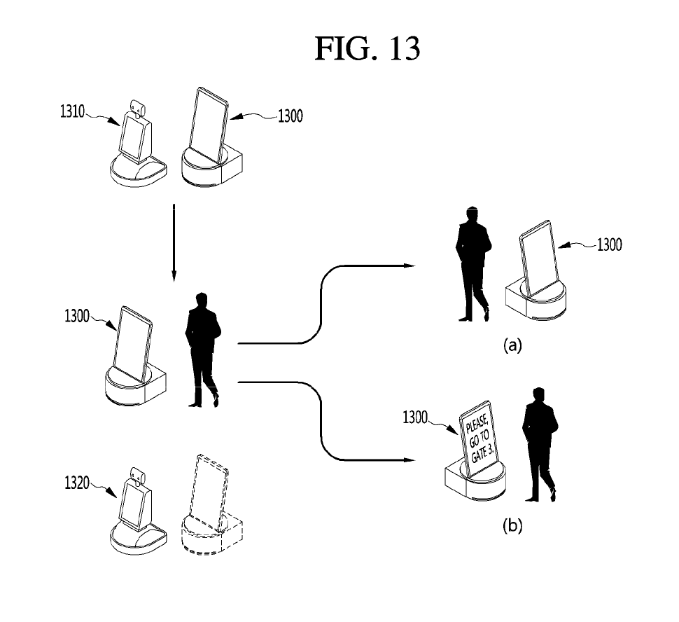

FIG. 13 is a view illustrating that an assistant robot performs a function of a guiding robot according to an embodiment of the present invention.

As illustrated in FIG. 13, an assistant robot 1300 may perform operations requested by a plurality of airport robots 1310 and 1320 while circulating a specific area of an airport. The assistant robot 1300 may finish the operation requested by the first airport robot 1310 and may move to perform the operation requested by the second airport robot 1320. In this case, the user in the airport may approach the assistant robot 1300, which is moving, to input the request for guiding directions. The assistant robot 1300 may include a display unit. As illustrated in (a) of FIG. 13, the assistant robot 1300 may perform an operation of guiding to a destination required by a user depending on the request of the user. In addition, as illustrated in (b) of FIG. 13, the assistant robot 1300 may output, to the display unit, a graphic user interface (GUI) for guiding directions of the user. In addition, the assistant robot 1300, which has finished the guiding of the directions for the user, may approach the second airport robot 1320 and may perform the requested operation.

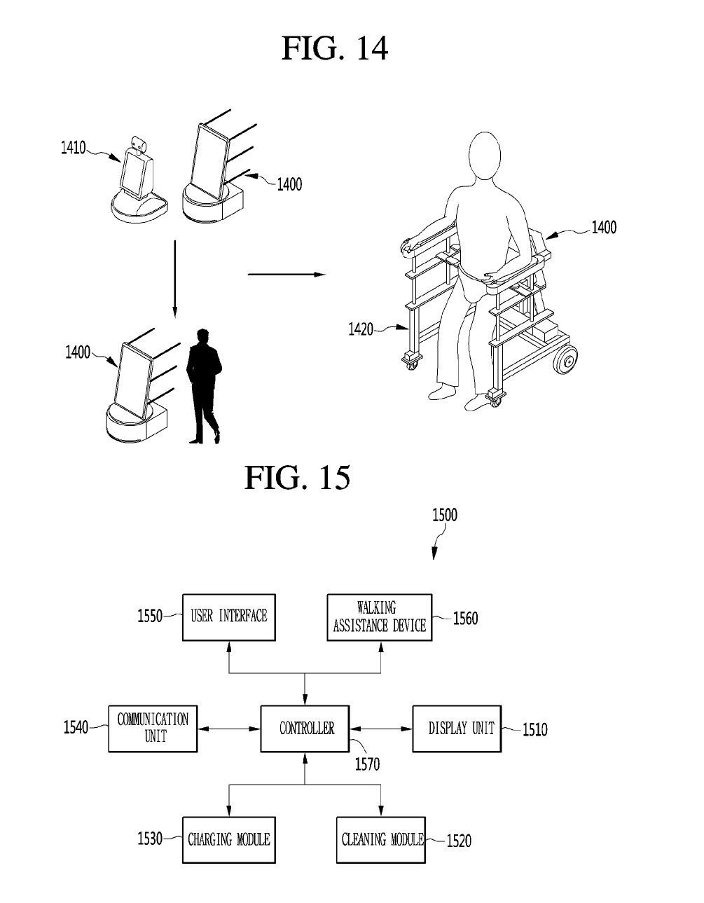

FIG. 14 is a view illustrating that the assistant robot performs a walking assisting operation according to an embodiment of the present invention.

As illustrated in FIG. 14, an assistant robot 1400 may perform an operation requested by an airport robot 1410 while circulating a specific area of an airport. The assistant robot 1400 may finish the operation requested by the airport robot 1410 and may move to perform the operation requested by another airport robot. In this case, a user in the airport may approach the assistant robot 1400, which is moving, to input the request for assisting walking. The assistant robot 1400 may include a display unit to provide a service such as guiding of directions. Further, the assistant robot 1400 may include a walking assistance device 1420 on the back surface of the assistant robot 1400 to provide a walking assisting service. As illustrated in FIG. 14, the assistant robot 1400 may provide the walking assistant device 1420 to the user according to the request by the user. The user may comfortably move to a desired destination by using the walking assistant device 1420. In addition, the assistant robot 1400, which has finished an operation of providing the walking assisting service for the user, may approach another airport robot and may perform the requested operation.

FIG. 15 is a block diagram illustrating the components of the assistant robot according to an embodiment of the present invention.

Hereinafter, the summary of the airport assistant robot according to an embodiment of the present invention having described with reference to FIGS. 4 to 14 will be described with reference to FIG. 15, which is obtained by simplifying block diagrams of FIGS. 1 and 2.

According to an embodiment of the present invention, an assistant robot 1500 to assist an airport robot may include a communication unit 1540 to transmit or receive data, a display unit 1510 to display at least one image, a charging module 1530 to charge a battery of the airport robot, and a controller 1570 to control an operation of the assistant robot. The controller 1570 may identify a battery level of the airport robot. The controller 1570 may determine whether to charge the battery, based on the identified battery level. The controller 1570 may connect the charging module 1530 to an airport robot, based on the determined state. In addition, the controller 1570 may perform a control operation to charge the battery of the airport robot to a preset battery level. The communication unit 1540 may receive, from a server, a message for requesting for charging the battery of the airport robot. In addition, the controller 1570 may control the assistant robot to move within a preset distance from the airport robot, based on the message. In addition, the communication unit 1540 may receive a message including information on the battery level from the airport robot, when the assistant robot approaches within the preset distance from the airport robot. The preset battery level may be 100%. In addition, the preset battery level may allow the airport robot to be movable to a battery charging station. In addition, the controller 1570 may calculated a distance between the airport robot and the battery charging station. In addition, the controller 1570 may calculate a battery level necessary for the airport robot to move a battery charging station, based on the calculated distance. In addition, the assistant robot 1500 may further include a cleaning module 1520 to clean a dust canister. In addition, the controller 1570 may check a dust canister state of the airport robot, when charging the airport robot, and may clean the dust canister of the airport robot by using the cleaning module 1520. In addition, when the assistant robot 1500 is charging the airport robot, the controller 1570 may perform a control operation to output, to the display unit 1510, a message for notifying that the battery is being charged. In addition, when the assistant robot 1500 is cleaning the dust canister of the airport robot, the controller 1570 may perform a control operation to output, to the display unit 1510, a message for notifying that the dust canister is being cleaned. In addition, the assistant robot 1500 may further include a user interface 1550 including a touch monitor. In addition, the assistant robot 1500 may receive an input for requesting for guiding a direction through the touch monitor from a user. In addition, when receiving the input for requesting for guiding the direction, the controller 1570 may calculate the moving path and the moving distance from a current position and to destination. In addition, the assistant robot 1500 may move to the destination together with the user, when the calculated moving distance is equal to or greater than a preset distance. In addition, in the assistant robot 1500, the controller 1570 may perform a control operation to output a map image including information on the moving path to a display unit 1510, when the calculated moving distance is less than the preset distance. The assistant robot 1500 may include a walking assistance device 1560. In addition, the assistant robot 1500 may adjust a height of the walking assistance device 1560 corresponding to a body size of the user, when moving to the destination together with the user.

An airport robot assisting system to assist an airport robot according to an embodiment of the present invention, which has been described with reference to FIGS. 4 to 14, may include a plurality of airport robots, a server, and a plurality of assistant robots. The server may receive an assistance requesting message from the plurality of airport robots. In addition, the server may transmit the received assistance requesting message to at least one of the plurality of assistant robots. The plurality of assistant robots may include at least one of a charging robot to charge batteries of the airport robots, a repairing robot to repair predetermined devices of the airport robots, or a guiding robot to provide a direction guide service. The assistance requesting message may be at least one of a charging requesting message, a repairing requesting message, or a guiding requesting message. The server may determine a type of an assistant robot providing a relevant assisting function based on the received assistance requesting message. In addition, the server may determine an assistant robot, which is positioned in a place closest to the airport robot having transmitted the assistance requesting message, of assistant robots having the determined type. In addition, the server may transmit the assistance requesting message to the determined assistant robot. The system may include a managing robot to manage the plurality of assistant robots, and the server may transmit the assistance requesting message to the managing robot. In addition, the managing robot may determine a type of an assistant robot providing a relevant assisting function based on the received assistance requesting message. In addition, the managing robot may determine an assistant robot, which is positioned in a place closest to the airport robot having transmitted the assistance requesting message, of assistant robots having the determined type. In addition, the managing robot may transmit the assistance requesting message to the determined assistant robot.

The above-described invention is able to be implemented with computer-readable codes on a medium having a program. Computer-readable medium includes all types of recording devices having data which is readable by a computer system. For example, the computer-readable medium includes a hard disk drive (HDD), a solid state disk (SSD), a silicon disk drive (SDD), a ROM, a RAM, a CD-ROM, a magnetic tape, a floppy disk, or an optical data storage device. In addition, the recording medium is implemented in the form of carrier waves (e.g., transmission over the Internet). In addition, the computer may include an AP 150 of the airport robot. Accordingly, the detailed description should be understood by way of example instead of being limitedly interpreted in terms of all aspects. The scope of the present invention should be determined by the reasonable interpretation of attached claims, and the equivalents of the present invention falls within the scope of the present invention.

1.-20. (canceled)

21. An assistant robot to assist a primary robot, the assistant robot comprising:
a communicator to transmit or receive data;
a charger to charge a battery; and
a controller to control an operation of the assistant robot, the controller being configured to:
identify a battery level of a battery of the primary robot;
determine whether to charge the battery of the primary robot, based on an identified battery level;
connect the charger to the primary robot, based on the determined state of the battery of the primary robot; and
charge the battery of the primary robot to a preset battery level.

22. The assistant robot of claim 21, wherein the communicator is configured to receive, from a server, a message requesting charging of the battery of the primary robot, and
wherein the controller is configured to control the assistant robot to move within a preset distance from the primary robot, based on the message.

23. The assistant robot of claim 22, wherein the communicator is further configured to receive, from the primary robot, a message including information on the battery level of the primary robot, when the assistant robot approaches within the preset distance from the primary robot.

24. The assistant robot of claim 21, wherein the preset battery level is 100%.

25. The assistant robot of claim 21, wherein the preset battery level is sufficient to permit the primary robot to move to a battery charging station.

26. The assistant robot of claim 25, wherein the controller is further configured to:
calculate a distance between the primary robot and the battery charging station; and
calculate a battery level necessary for the primary robot to move to the battery charging station, based on the calculated distance.

27. The assistant robot of claim 21, further comprising a cleaner to clean a dust canister,
wherein the controller is further configured to:
determine a state of a dust canister of the primary robot; and
operate the cleaner to clean the dust canister of the primary robot, based on the determined state of the dust canister.

28. The assistant robot of claim 27, further comprising a display to display at least one image,
wherein the controller is further configured to output, to the display, a message indicating that the dust canister is being cleaned, when the assistant robot is cleaning the dust canister of the primary robot.

29. The assistant robot of claim 21, further comprising a display to display at least one image,
wherein the controller is further configured to output, to the display, a message indicating that the battery is being charged, when the assistant robot is charging the battery of the primary robot.

30. The assistant robot of claim 21, further comprising a user interface including a touch monitor,
wherein the touch monitor is configured to receive an input from a user for requesting a guiding direction.

31. The assistant robot of claim 30, wherein the controller is further configured to perform a control operation when the input for requesting the guiding direction is received, the control operation including:
calculating a moving path of the assistant robot and a moving distance of the assistant robot from a current position of the assistant robot to a destination;
moving the assistant robot to the destination, when the calculated moving distance is equal to or greater than a preset distance; and
outputting a map image including information on the moving path to a display provided in the assistant robot, when the calculated moving distance is less than the preset distance.

32. The assistant robot of claim 31, further comprising a walking assistance device,
wherein the control operation further includes adjusting a height of the walking assistance device to correspond to a body size of the user when moving the assistant robot to the destination together with the user.

33. A robot assisting system to assist a primary robot, the robot assisting system comprising:
a plurality of primary robots;
a server; and
a plurality of assistant robots,
wherein the server is configured to:
receive an assistance requesting message from any of the plurality of primary robots; and
transmit the received assistance requesting message to at least one of the plurality of assistant robots.

34. The robot assisting system of claim 33, wherein the plurality of assistant robots includes at least one of a charging robot to charge batteries of the primary robots, a repairing robot to repair predetermined devices of the primary robots, or a guiding robot to provide a direction guide service.

35. The robot assisting system of claim 34, wherein the assistance requesting message is at least one of a charging requesting message, a repairing requesting message, or a guiding requesting message.

36. The robot assisting system of claim 35, wherein the server is configured to:
determine a type of assistant robot providing a relevant assisting function based on the received assistance requesting message;
determine an assistant robot, of assistant robots having the determined type, which is positioned in a place closest to the primary robot having transmitted the assistance requesting message; and
transmit the assistance requesting message to the determined assistant robot.

37. The robot assisting system of claim 35, further comprising a managing robot to manage the plurality of assistant robots,
wherein the server is configured to transmit the assistance requesting message to the managing robot, and
wherein the managing robot is configured to:
determine a type of assistant robot providing a relevant assisting function based on the received assistance requesting message;
determine an assistant robot, of assistant robots having the determined type, which is positioned in a place closest to the primary robot having transmitted the assistance requesting message; and
transmit the assistance requesting message to the determined assistant robot.

38. A non-transitory computer-readable storage medium including computer-executable instructions to be executed by a processing system, the computer-executable instructions being provided to assist primary robots, the computer-executable instructions including:
instructions to receive an assistance requesting message from at least one primary robot;
instructions to determine a type of an assistant robot providing a relevant assisting function based on the received assistance requesting message;
instructions to determine an assistant robot, of assistant robots having the determined type, which is positioned in a place closest to the primary robot having transmitted the assistance requesting message; and
instructions to transmit the assistance requesting message to the determined assistant robot.

39. The non-transitory computer-readable storage medium of claim 38, wherein the instructions to receive an assistance requesting message include instructions to receive at least one of a charging requesting message, a repairing requesting message, or a guiding requesting message.

40. The non-transitory computer-readable storage medium of claim 38, wherein the instructions to determine the type of assistant robot including instructions to determine at least one of a charging type for charging batteries of the primary robots, a repairing type for repairing predetermined devices of the primary robots, or a guiding type for providing a direction guide service.
